(19) United States
(12) Patent Application Publication
(10) Pub. No.: US 2017/0019463 A1
(43) Pub. Date: Jan. 19, 2017

(54) COMMUNICATION SYSTEM, COMMUNICATION DEVICE AND COMMUNICATION METHOD

(71) Applicant: FUJITSU LIMITED, Kawasaki-shi (JP)

(72) Inventor: Tomoyuki Tsunoda, Kawasaki (JP)

(21) Appl. No.: 15/192,197

(22) Filed: Jun. 24, 2016

(30) Foreign Application Priority Data
Jul. 14, 2015 (JP) 2015-140104

(51) Int. Cl. H04L 29/08; H04L 12/26; H04L 12/44

(52) U.S. Cl. CPC H04L 67/104; H04L 12/44; H04L 67/322; H04L 67/14; H04L 43/16

(57) ABSTRACT

A communication system includes a first communication device, a plurality of transfer destination devices and a plurality of communication devices. The first communication device receives distribution of data and transfers the data to the plurality of transfer destination devices. The plurality of communication devices receive the data via any of the plurality of transfer destination devices. The first communication device requests that a second communication device included among the plurality of transfer destination devices receive the data from a third communication device included among the plurality of communication devices when reception quality of the data in the third communication device is higher than reception quality of the data in the second communication device. The second communication device receives a request from the first communication device and changes a connection destination from the first communication device to the third communication device.

### CROSS-REFERENCE TO RELATED APPLICATION

This application is based upon and claims the benefit of priority of the prior Japanese Patent Application No. 2015-140104, filed on Jul. 14, 2015, the entire contents of which are incorporated herein by reference.

### FIELD

The embodiments discussed herein are related to a communication system and a communication method used in a communication system.

### BACKGROUND

Peer-to-peer (P2P) communication processes performed between communication devices sometimes use a data distribution system in which data is distributed to a plurality of devices. Such a data distribution system sometimes uses a tree network having the data distribution source as its origin. Each communication device in a data distribution system monitors the reception quality and when the reception quality in itself has fallen below a prescribed threshold, it disconnects the communication with the connection destination and starts a communication with a different device that it may communicate with in the data distribution system.

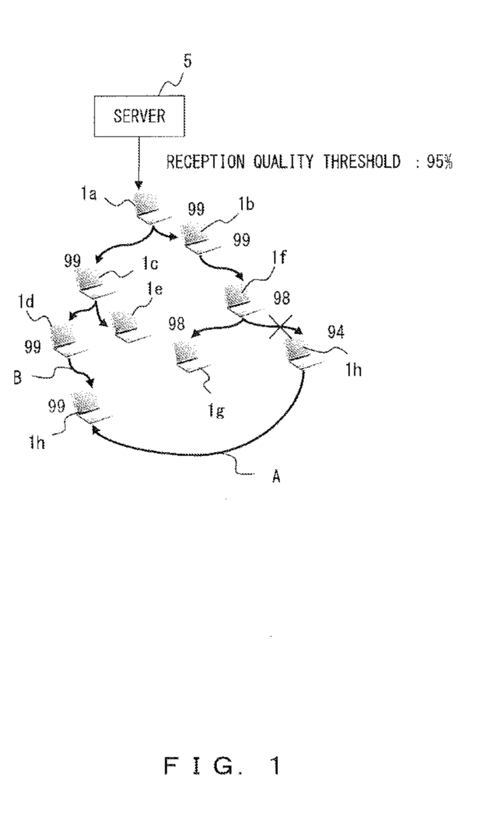

FIG. 1 illustrates an example of a data distribution system. The data distribution system illustrated in FIG. 1 includes a server 5 and communication devices 1a through 1h, and the communication device 1h is assumed to be connected to the communication device 1f when a communication starts. The server 5 distributes data to the communication device 1a, and the communication device 1a transmits the data received from the server 5 to the communication devices 1b and 1c. The communication device 1b transmits the data received from the communication device 1a to the communication device 1f. Similarly, the communication device 1c transmits the data received from the communication device 1a to the communication devices 1d and 1e. Meanwhile, the communication device 1f transmits the data received from the communication device 1b to the communication devices 1g and 1h. In FIG. 1, the value appearing around each of the communication devices represents a percentage of data that has correctly been received by that communication device with respect to the data distributed from the server. For example, the communication devices 1a through 1d have correctly received 99% of the distributed data while the communication devices 1e through 1g have correctly received 98% of the distributed data. The communication device 1h has correctly received 94% of the distributed data.

It is now assumed that all communication devices have the thresholds (reception quality thresholds) set to be 95% for determining whether or not the communication device is to change a connection destination. In such a case, each communication device does not change a connection destination when it is correctly receiving at least 95% of the distributed data, while it changes a connection destination when the percentage of correctly received data has fallen below 95%. In the example illustrated in FIG. 1, data received when the communication device 1h is connected to communication device 1f is 94% of the distributed data, making the communication device 1h determine to change a connection destination from communication device 1f to a different device. Detecting that a connection to communication device 1d is possible, the communication device 1h changes the connection destination to communication device 1d as depicted by arrow A. In the example illustrated in FIG. 1, the communication device 1h receives data from communication device 1d as depicted by arrow B after changing the connection destination to the communication device 1d, and is receiving 99% of the distributed data. Accordingly, the communication device 1h obtains data by treating the communication device 1d as a connection destination.

As a related art, a method is proposed in which a child terminal communicating with a parent terminal for which the remaining number of communication routes that may be formed between child terminals has become equal to or smaller than threshold K1 changes its connection destination to a parent terminal for which the remaining number of communication routes that may be formed is greater than threshold K2. A route setting method is also proposed in which a communication device in a multi-hop wireless network uses a route selected from among routes obtained through a prescribed calculation using addresses, and thereby determines a relay destination.

Documents such as Japanese Laid-open Patent Publication No. 2012-70368, Japanese Laid-open Patent Publication No. 2009-200768, etc. for example are known.

A high threshold used by a communication device for determining whether or not to change a connection destination reduces the number of communication devices that may distribute data, and in view of this thresholds are sometimes set to be equal to or smaller than a value that is assumed to allow the user to use received data without stress. In such a case, even a communication device with reception quality just slightly higher than the threshold does not change its connection destination until the reception quality becomes lower than the threshold. Because it is not possible that the reception quality in a communication device that is on a downstream side in a data distribution system is higher than that of its connection destination, a communication device with reception quality slightly higher than the threshold existing on the upstream side is likely to have the worse reception quality in communication devices on the downstream side.

### SUMMARY

According to an aspect of the embodiments, a communication system includes a first communication device that receives distribution of data, a plurality of transfer destination devices to which the first communication device transfers the data, and a plurality of communication devices that receive the data via one of the plurality of transfer destination devices. When the reception quality of the data in the second communication device included among the plurality of transfer destination devices is higher than the reception quality of the data in a third communication device, the first communication device requests that the second communication device receive the data from the third communication device. The third communication device is a device included among the plurality of communication devices. The second communication device receives a request from the first communication device. The second communication device changes its connection destination from the first communication device to the third communication device.

The object and advantages of the invention will be realized and attained by means of the elements and combinations particularly pointed out in the claims.

It is to be understood that both the foregoing general description and the following detailed description are exemplary and explanatory and are not restrictive of the invention.

### DESCRIPTION OF EMBODIMENTS

FIG. 1 explains an example of a data distribution system;

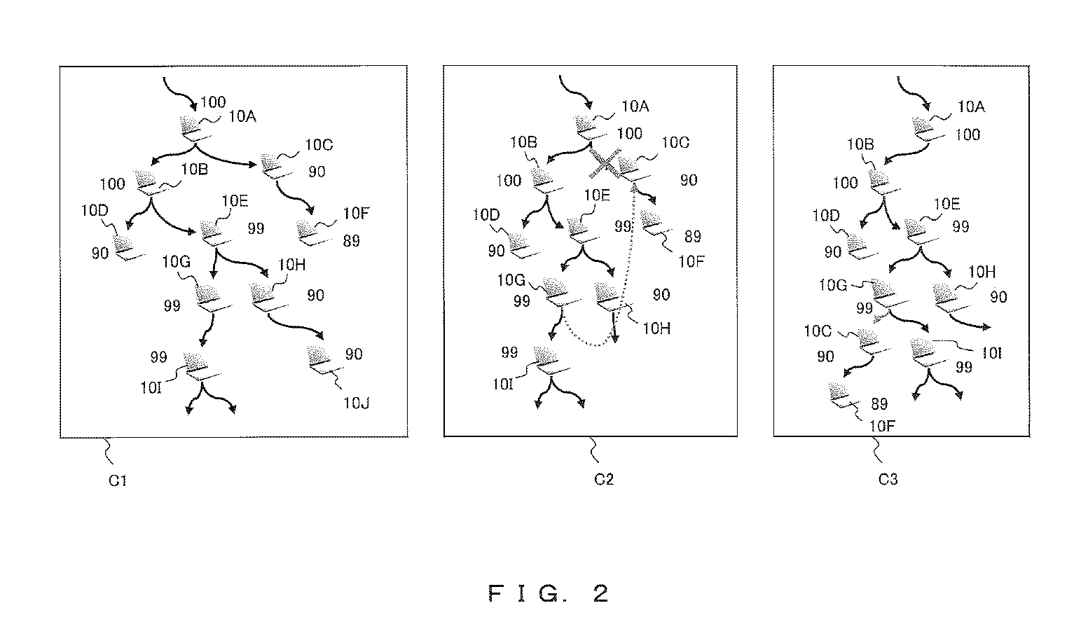

FIG. 2 explains an example of a communication method according to an embodiment;

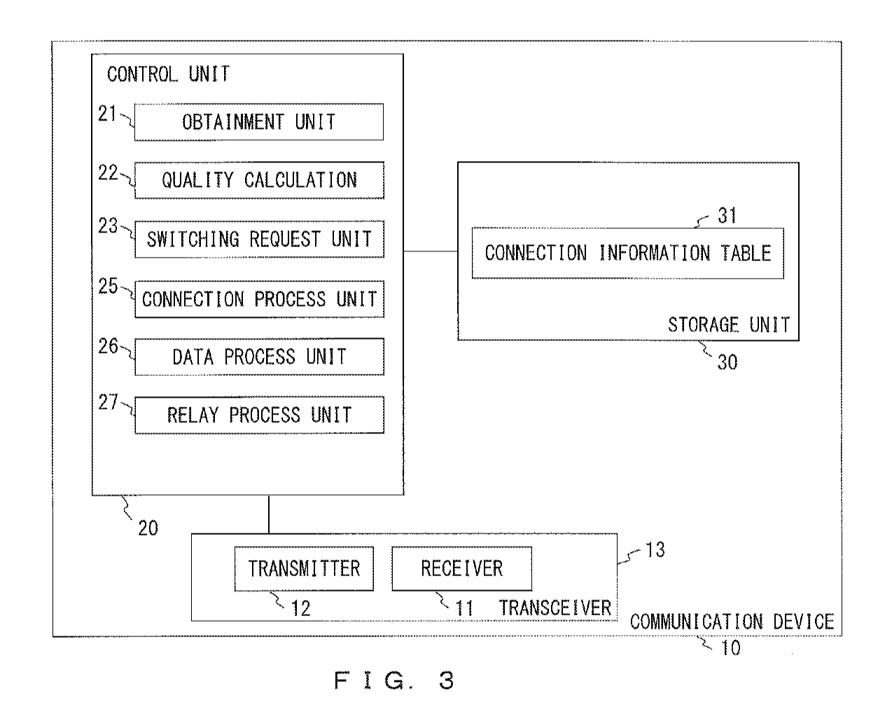

FIG. 3 explains an example of a configuration of a communication device;

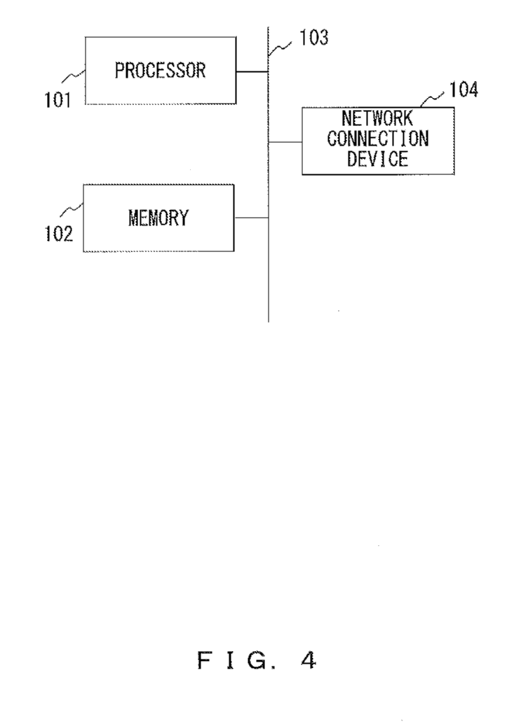

FIG. 4 explains an example of a hardware configuration of a communication device;

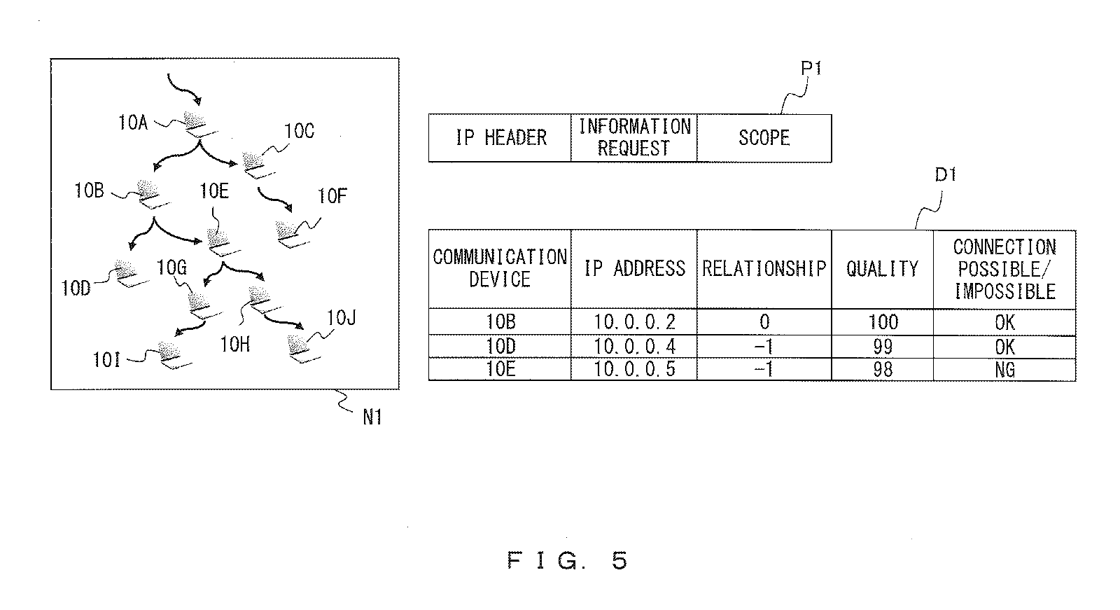

FIG. 5 explains an example of a method of obtaining quality information from a data transfer destination;

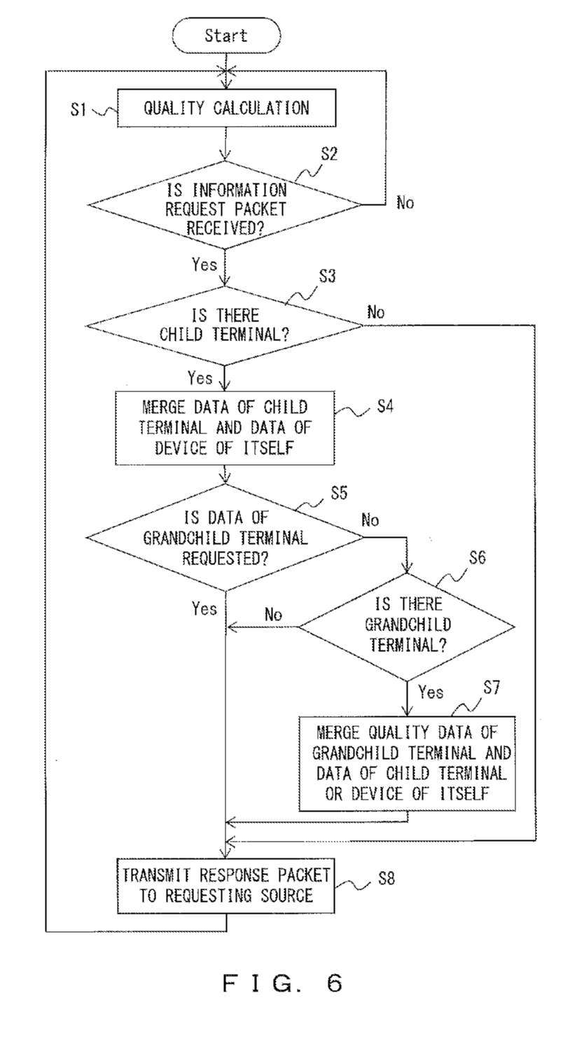

FIG. 6 is a flowchart explaining an example of a method of reporting quality information;

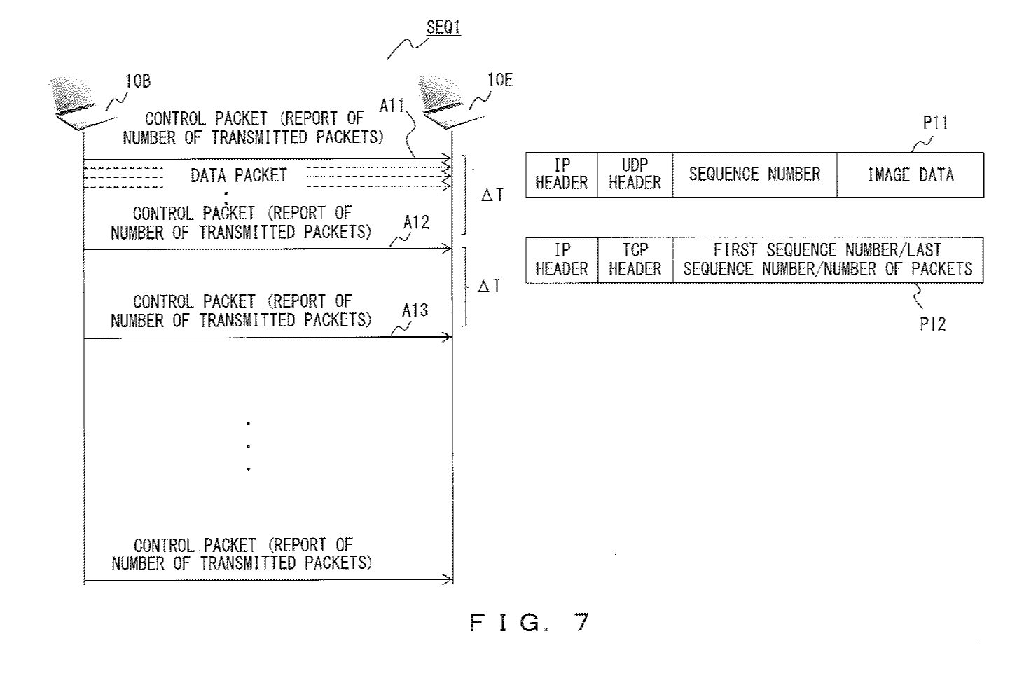

FIG. 7 explains an example of a method of calculating reception quality;

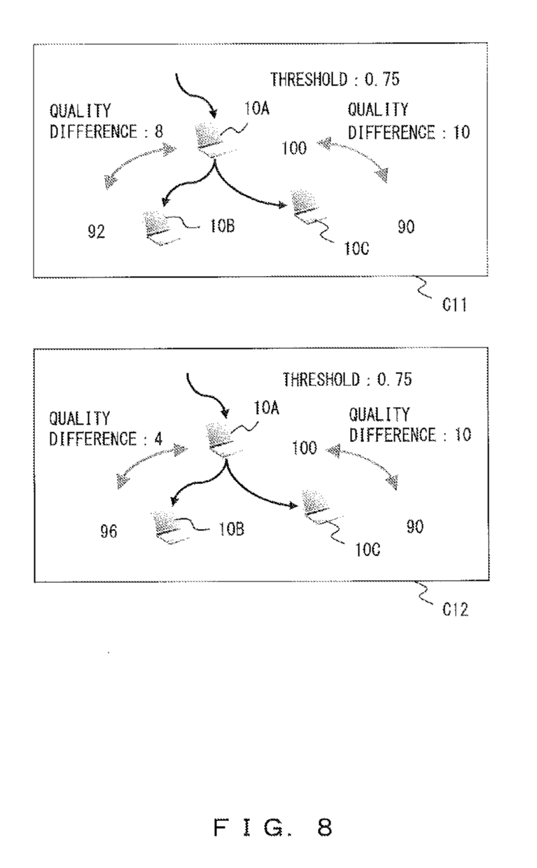

FIG. 8 explains an example of a method of determining whether or not there is a significant difference in reception quality;

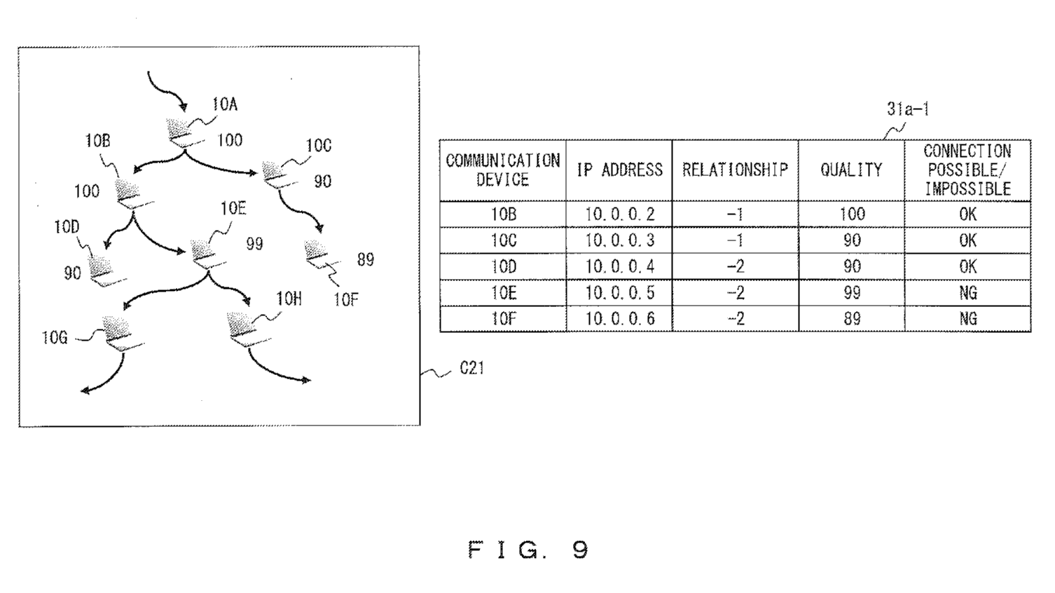

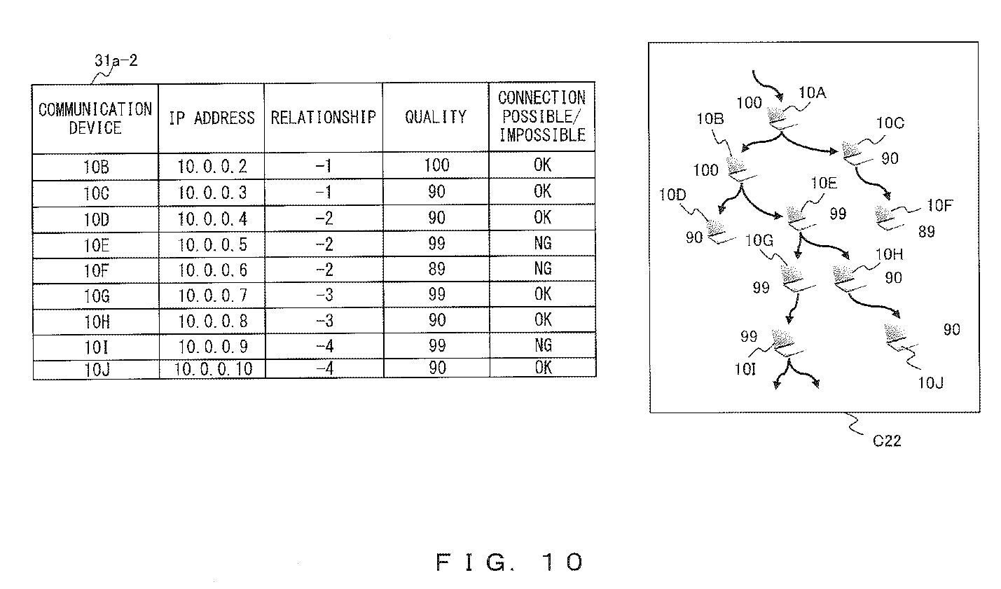

FIG. 9 explains an example of a method of searching for a connection destination;

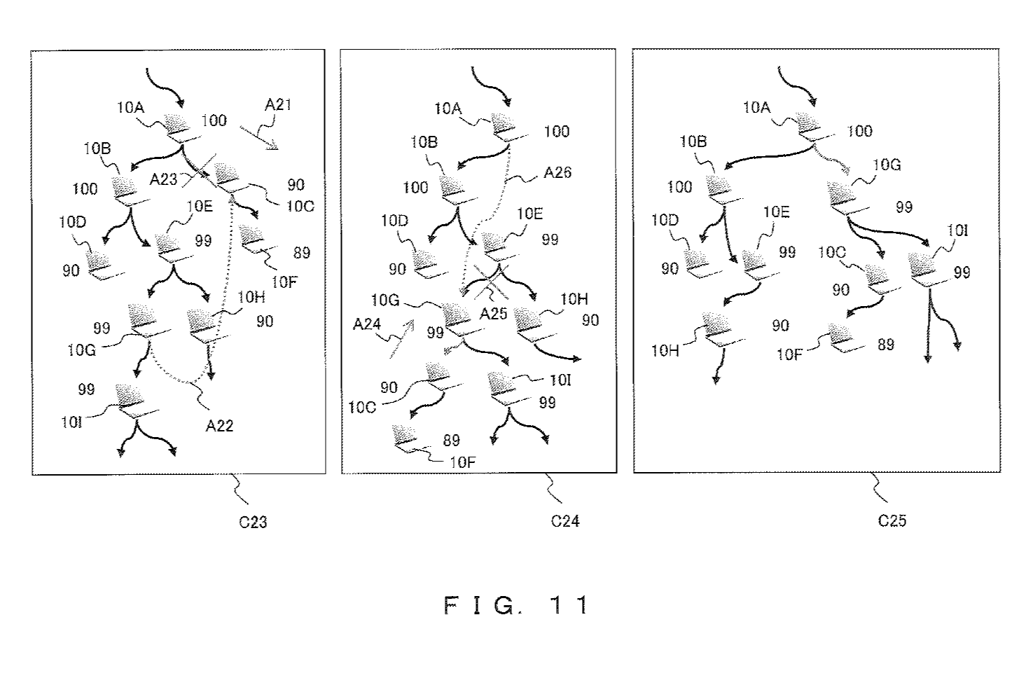

FIG. 10 explains an example of a method of searching for a connection destination;

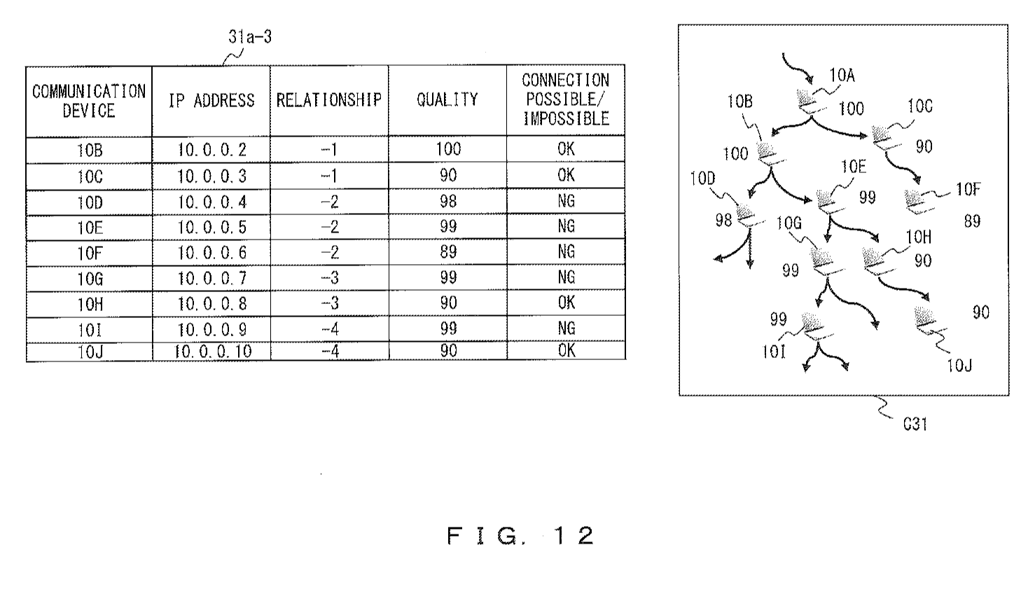

FIG. 11 explains an example of a process of changing a connection destination;

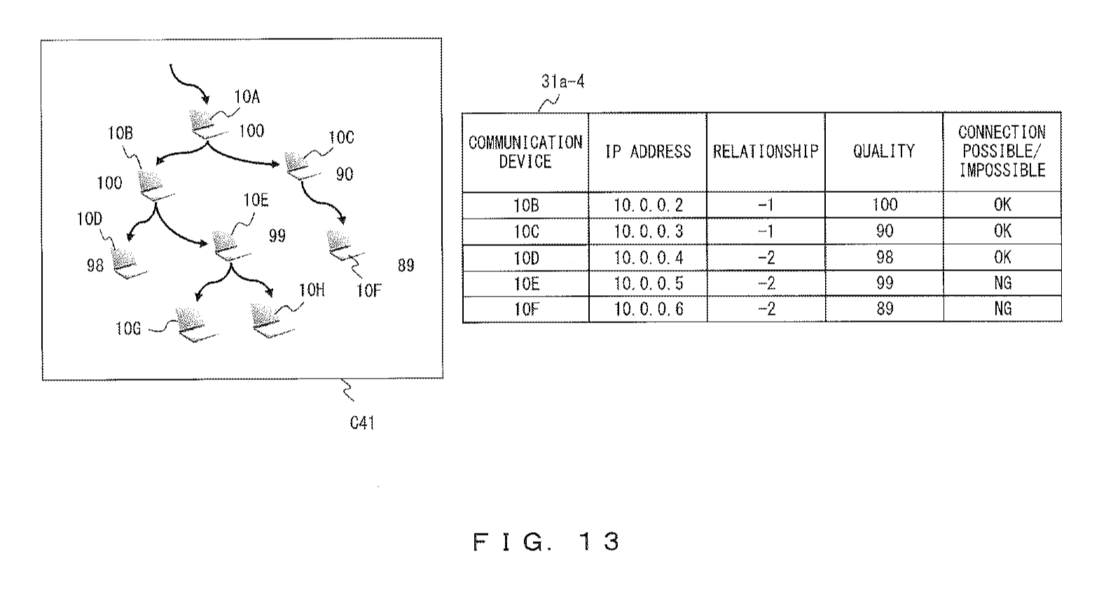

FIG. 12 explains an example of a method of searching for a connection destination;

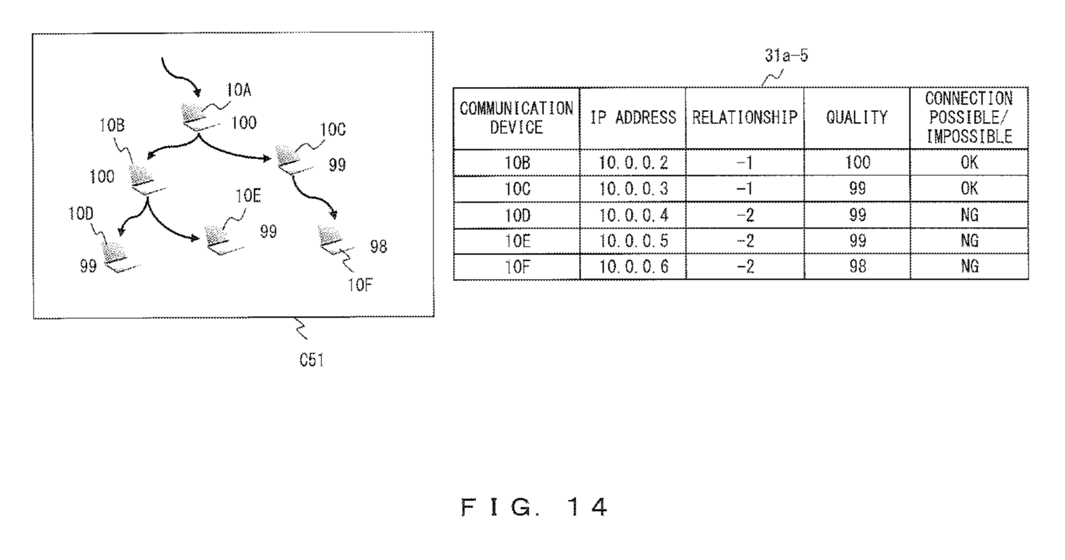

FIG. 13 explains an example of a method of searching for a connection destination;

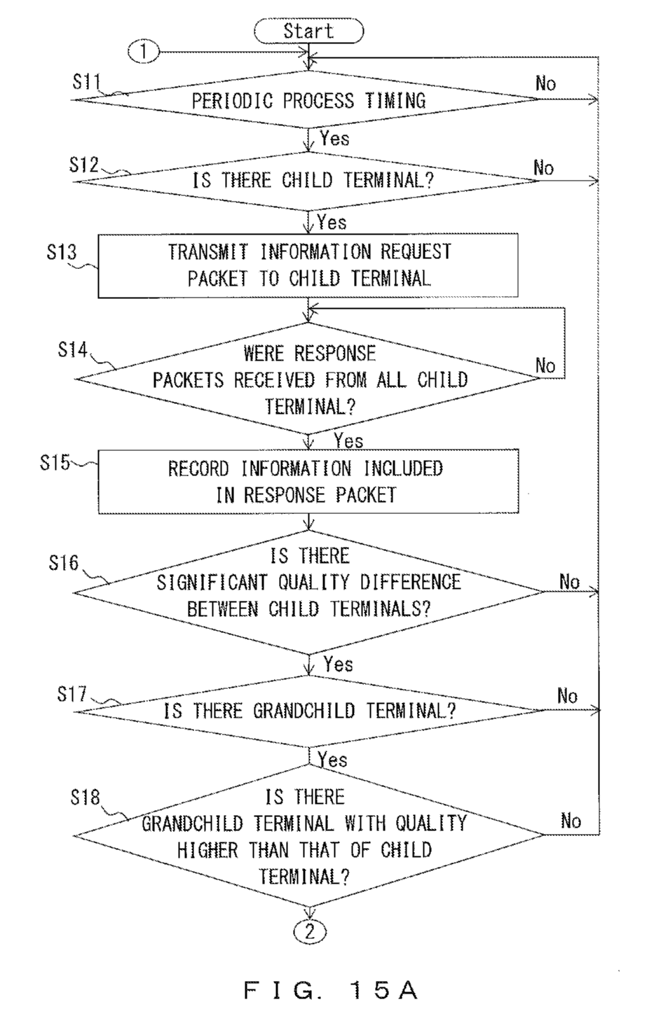

FIG. 14 explains an example of a method of searching for a connection destination;

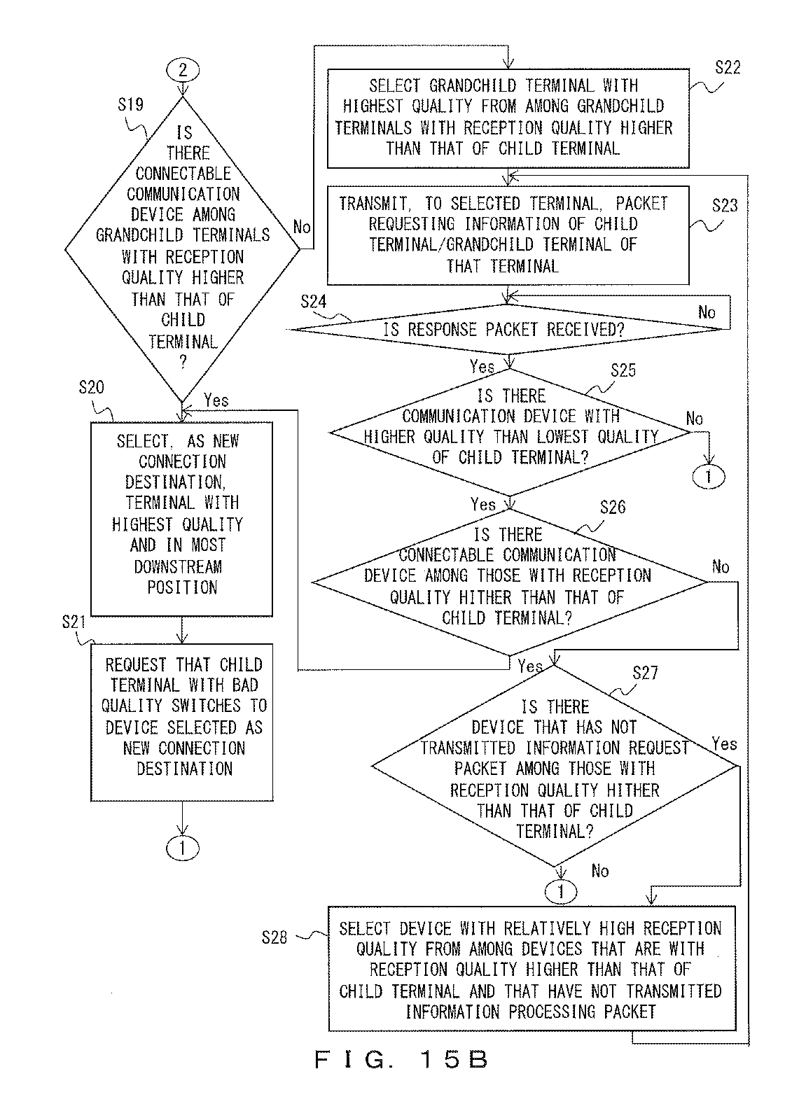

FIG. 15A is a flowchart explaining an example of a method of searching for a connection destination;

FIG. 15B is a flowchart explaining an example of a method of searching for a connection destination;

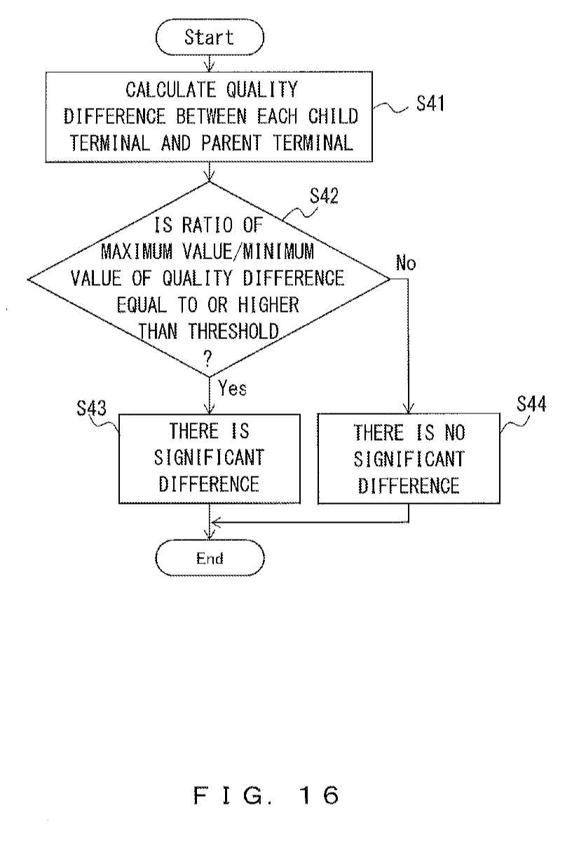

FIG. 16 is a flowchart explaining an example of a method of comparing levels of reception quality; and

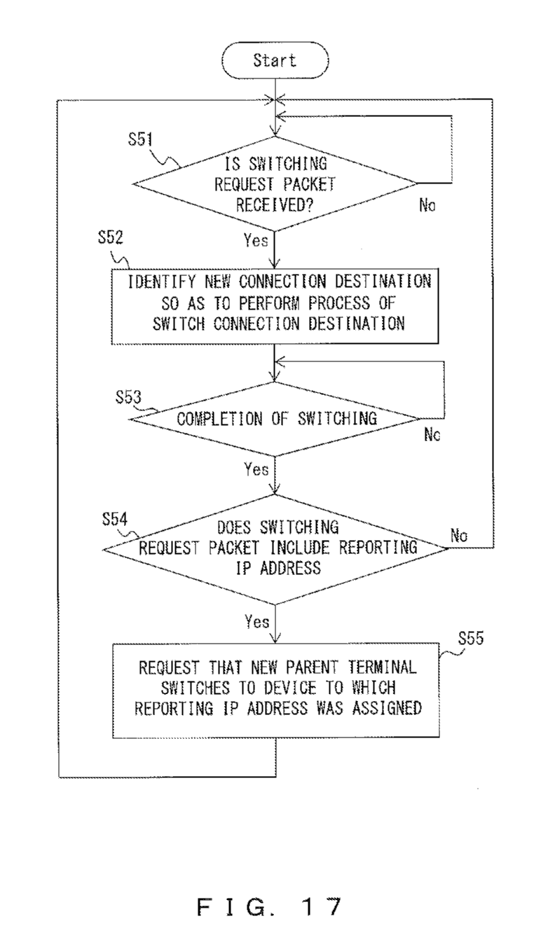

FIG. 17 is a flowchart explaining an example of a method of changing a connection destination.

### DESCRIPTION OF EMBODIMENTS

FIG. 2 illustrates an example of a communication method according to an embodiment. Case C1 is an example of a distribution system in which communication devices 10A through 10J are receiving the data distribution. The solid arrow drawn from each of the communication devices 10 represents that that communication device 10 is transferring data to a different communication device 10. The communication device 10A for example is transferring data to the communication devices 10B and 10C, while the communication device 10B is transferring data to communication devices 10D and 10E. In the explanations below, the communication devices 10 as transmission destinations may be omitted due to space limitation. For example, the two arrows drawn from the communication device 10I indicate that the communication device 10I is transferring data to two other communication devices 10, but the transfer destinations of the data from the communication device 10I are not shown. In FIG. 2 and subsequent figures, the percentage of data received correctly in each communication device appears in the vicinity of that communication device 10 similarly to FIG. 1.

In the example of case C1, while the communication devices 10A and 10B have received all packets transmitted from a server 5 (not shown), the communication device 10C have received only 90% of the transmitted packets. Because the communication device 10C has succeeded in receiving only 90% of the transmitted packets, the communication devices 10 that receive packets via the communication device 10C receive data at the quality equal to or lower than that in the communication device 10C. In communication device 10F, which is receiving packets from the communication device 10C, for example, only 89% of the transmitted packets are received.

Hereinafter, in order to facilitate understanding of connection relationships between a plurality of devices, a data transfer destination of a communication device 10 is referred to as a “child terminal” of that device. Similarly, a communication device 10 that receives data from a child terminal of a device is also referred to as a “grandchild terminal” of that device. Also, a communication device 10 that is transmitting data to a child terminal is also referred to as a “parent terminal” of that child terminal. Further, a device that obtains data via a transfer destination (child terminal) of data of a communication device 10 includes a device that receives data via a child terminal, such as a grandchild terminal of a communication device 10, a device obtaining data from that grandchild terminal, etc.

The communication device 10A periodically obtains, from the communication devices 10B and 10C as data transfer destinations, information representing the reception quality of each device and information representing whether or not a connection of a new device is possible. In this obtainment, the communication device 10A may also obtain information of a grandchild terminal from the communication devices 10B and 10C, which are child terminals. The communication device 10A may also obtain, from a grandchild terminal, information of each grandchild terminal and the communication device 10 that is receiving data via each grandchild terminal. Accordingly, the communication device 10A may recognize for example the state of the network illustrated in case C1. For example, the communication device 10A may identify that the reception quality is 90% in the communication device 10C, which is a child terminal of the communication device 10A. Further, the communication device 10A may also identify that the reception quality is 99% in the communication device 10G that is receiving data via the communication device 10E, which is a grandchild terminal of the communication device 10A. Then, the communication device 10A determines to move the communication device 10C to the downstream side because the communication devices 10G etc. that are on the downstream side of the communication device 10C, which is a child terminal, have higher reception quality than that in the communication device 10C. The communication device 10A requests that the communication device 10C change the connection destination from the communication device 10A to the communication device 10G.

Case C2 illustrates an example of switching of connections. In case C2, the dotted arrow drawn from the communication device 10G to the communication device 10C indicates that the communication device 10C has moved to the downstream side of the communication device 10G and also represents the flow of data to the communication device 10C. Also, the X mark on the solid arrow drawn from the communication device 10A toward communication device 10C indicates that the communication device 10C disconnects a communication with the communication device 10A.

Case C3 illustrates an example of a network obtained through the process in case C2. In the network illustrated as case C3, the communication device 10B is connected to the communication device 10A, while the communication device 10C is not connected to the communication device 10A. The communication device 10C is connected to the communication device 10G, which is on the downstream side of a child terminal of the communication device 10A. Accordingly, the communication device 10C is connected to the communication device 10A via three communication devices, i.e., the communication devices 10B, 10E and 10G, and is located in a more downstream portion than in case C2.

As described above, in the method according to an embodiment, the communication device 10 with low reception quality moves from the upstream side to the downstream side. Accordingly, it is possible to reduce a possibility that a connection of a device with low reception quality such as the communication device 10C in the upstream side will lower the reception quality in a device that receives data. Deterioration in reception quality may also result in an increase in retransmissions and communication disconnections, leading to a possibility that the communication will not be performed efficiently. The method according to an embodiment moves the communication device 10 with low reception quality to the downstream side, also preventing a situation where deterioration in reception quality lowers the communication efficiency.

Further, the moving of the communication device 10C to the downstream side makes it possible for other communication devices 10 to be connected to the communication device 10A. Thereby, the communication device 10 that is newly participating in the data distribution system may be connected to the communication device 10A. Also, connecting a communication device 10 with relatively high reception quality to the communication device 10A from among the communication device 10 that have already participated in the data distribution system makes it possible to reduce the number of layers in the system so as to increase further the communication efficiency. In case C3 for example, the communication device 10A and the communication device 10F, which is farthest from the transmission source, are connected via four communication devices 10. By connecting the communication device 10G instead of the communication device 10C to the communication device 10A in this situation, the communication device 10F may be connected to the communication device 10A via the communication devices 10G and 10C. In such a case, the number of transfer processes performed between the transmission of data from the communication device 10A and the reception of the data in the communication device 10F is reduced, making it easier to prevent deterioration in the reception quality in a communication device 10 such as the communication device 10F, which is farthest from the transmission source.

While FIG. 2 illustrates an example in which the communication device 10A moves other communication devices 10 or determines a movement destination, the above explanations are just exemplary. Any communication device 10 to which a child terminal and a grandchild terminal are connected in a network may also determine whether or not to change a connection destination of a device that is receiving data via that communication device 10 and may specify a new connection destination.

<Device Configuration>

FIG. 3 explains an example of a configuration of the communication device 10. The communication device 10 includes a transceiver 13, a control unit 20 and a storage unit 30. The storage unit 30 stores a connection information table 31. The control unit 20 includes an obtainment unit 21, a quality calculation unit 22, a switching request unit 23, a connection process unit 25, a data process unit 26 and a relay process unit 27.

The transceiver 13 includes a receiver 11 and a transmitter 12. The receiver 11 receives a packet from a different device such as the server 5, other communication devices 10, etc. The transmitter 12 transmits a packet to a different device such as the server 5, other communication devices 10, etc.

The obtainment unit 21 uses a packet received from a child terminal or a grandchild terminal so as to obtain information such as the reception quality in the communication device 10 that is connected on the downstream side of the device of the obtainment unit 21. The obtainment unit 21 records obtained information in the connection information table 31 on an as-needed basis. The quality calculation unit 22 calculates the reception quality of distributed data in the device of the quality calculation unit 22. The switching request unit 23 compares the reception quality in a child terminal with the reception quality in the communication device 10 that is receiving data via one of child terminals so as to determine whether or not to move the child terminal to the downstream side. When the communication device 10 receiving data via one of the child terminals has higher reception quality than that of the child terminal, the switching request unit 23 generates a control packet (switching request packet) for requesting the moving of a connection destination, the packet being addressed to the child terminal.

Receiving from a different communication device 10 a request to change a connection destination, the connection process unit 25 establishes a connection to the communication device 10 that has newly been specified as a connection destination. The data process unit 26 processes distributed data that it received during the participation in the data distribution system. The relay process unit 27 performs a process for relaying distribution target data for the communication device 10 that is receiving the distribution target data from the device of the relay process unit 27.

FIG. 4 illustrates an example of a hardware configuration of the communication device 10. The communication device 10 includes a processor 101, a memory 102, a bus 103 and a network connection device 104. The processor 101 is an arbitrary processing circuit including a central processing unit (CPU). The processor 101 uses the memory 102 as a working memory so as to execute a program and thereby performs various processes. The memory 102 includes a random access memory (RAM), and further includes a non-volatile memory such as a read only memory (ROM) etc. Also, the memory 102 stores a program on an as-needed basis. The bus 103 connects the processor 101, the memory 102 and the network connection device 104 so that data may be input to and output from each other. In the communication device 10, the processor 101 operates as the control unit 20, and the memory 102 operates as the storage unit 30. Further, the transceiver 13 is realized by the processor 101 and the network connection device 104. Note that the program may be provided in a form that it is stored in a non-transitory computer-readable recording medium and is installed in the communication devices 10.

### Embodiments

Hereinafter, a communication according to an embodiment will be explained as a method of obtaining information of a distribution destination, a method performed in each device for calculating the reception quality, determination whether or not to change a connection destination of a child terminal, searching for a connection destination, and changing of a connection destination. Hereinafter, in order to clearly express which of the communication devices 10 is performing processes, the lower-case character of the alphabetical character used as the identifier assigned to the communication device 10 may be added to the tail of the numerical symbol. For example, the obtainment unit 21a refers to the obtainment unit 21 included in the communication device 10A.

(1) Obtainment of Information of Connection Destination

FIG. 5 illustrates an example of a method of obtaining quality information from a data transfer destination. The network appearing as network N1 in FIG. 5 is used an example in the explanations below. In network N1, communication device 10A distributes data to communication devices 10B and 10C. The communication device 10B distributes data to the communication devices 10D and 10E, while the communication device 10E distributes data to the communication devices 10G and 10H. Further, communication device 10G distributes data to the communication devices 10I, the communication device 10H distributes data to the communication device 10J, and the communication device 10C is distributes data to the communication device 10F.

Each of the communication devices 10 to which a child terminal is connected periodically generates a control packet so as to allow the obtainment unit 21 to obtain, from the child terminal of the device of the obtainment unit 21, information related to the communication state of the child terminal, a grandchild terminal connected to that child terminal, and other aspects. Note that each communication device 10 is assumed to recognize the addresses of a connection destination of itself and its child terminal through the control conducted upon the establishment of the connection. Hereinafter, a control packet used for obtaining communication information is also referred to as an “information request packet”. It is assumed herein that the obtainment unit 21a of the communication device 10A generated an information request packet addressed to the communication device 10B for obtaining information of terminals up to a grandchild terminal of the communication device 10A.

P1 in FIG. 5 illustrates an example of a format of an information request packet. An information request packet includes an IP (internet protocol) header, information representing that the packet is an information request packet, and scope information. In this example, scope information is a value representing a scope over which the reporting of information is requested by the information request packet, and is a value representing up to which of the layers the reporting of terminal information is requested for, with reference to the device that received the information request packet. In the explanations below, scope information is a value obtained by multiplying, by −1, the number of the communication links used for the communication with the reference device. For example, when the information request packet is transmitted to the communication device 10B, the reference for a layer information becomes the communication device 10B. In this case, the layer of the communication device 10B is 0, the layer of the child terminals of the communication device 10B is −1, and the layer of the grandchild terminals of the communication device 10B is −2.

The receiver 11b of the communication device 10B receives an information request packet, and outputs it to the obtainment unit 21b. The obtainment unit 21b uses information recorded in the connection information table 31b and the reception quality in the communication device 10B calculated by the quality calculation unit 22b, and thereby generates data to be reported to the communication device 10A. Data D1 is an example of data generated by the obtainment unit 21b.

Data D1 illustrated in FIG. 5 includes information of the device that received an information request packet and information of a device on layers in a scope specified by the information request packet. Also, it include the identification information, the IP address, the relationship, the quality, and connection possible/impossible, for each of the communication devices 10. A relationship is a value representing, with reference to the communication device 10 having received the information request packet, the layer to which the communication target communication device 10 belongs. Because the communication device 10B for example is a device that received an information request packet from the communication device 10A, the relationship of the communication device 10B is 0 in the information reported from the communication device 10B to the communication device 10A. Meanwhile, because the communication devices 10D and 10E are both child terminals of the communication device 10B, the values of the relationships of the communication devices 10D and the 10E are both −1.

Quality is reception quality in a communication target communication device 10. A method of calculating reception quality will be described later in detail (FIG. 7). In the example illustrated in FIG. 5, it is assumed that the reception quality of the communication device 10B is 100%, the reception quality of communication device 10D 99% and the reception quality of the communication device 10E is 98%. Connection possible/impossible is information representing whether or not the communication target communication device 10 may form a new connection. In data D1, it is illustrated that the communication devices 10B and 10D may establish connection to new child terminals and the communication device 10E does not form a new connection. The obtainment unit 21b adds the information illustrated as data D1 to the header so as to generate a response packet addressed to the communication device 10A. The transmitter 12b transmits the response packet to the communication device 10A.

Receiving the response packet, the receiver 11a of the communication device 10A outputs it to the obtainment unit 21a. The obtainment unit 21a records, in the connection information table 31a, data included in the response packet. At the time of the recording, the obtainment unit 21a records in the connection information table 31a information reported from a child terminal regarding the identification information, the IP address, the quality and connection possible/impossible for the communication device 10, and changes the value of the relationship to a value based on the communication device 10A. For example, because data D1 is data transmitted from the communication device 10B, the communication device 10B serving as the reference in data D1 is a child terminal of the communication device 10A. Accordingly, for all devices included in data D1, the obtainment unit 21a records in the connection information table 31a a value obtained by subtracting one value representing the relationship. The above subtraction processes result in −1 as the relationship of communication device 10B, −2 as the relationship of the communication device 10D and −2 as the relationship of the communication device 10E. In other words, the fact that the communication device 10B is a child terminal of the communication device 10A and the fact that the communication devices 10D and 10E are grandchild terminals of the communication device 10A are recorded in the connection information table 31a.

A case where the communication device 10A transmits an information request packet to a child terminal and receives data from the child terminal has been explained by referring to FIG. 5, whereas the communication device 10 may also transmit an information request packet to a device that is on the downstream side of a child terminal, such as a grandchild terminal. In such a case as well, data obtained by response packet to an information request packet is stored in the connection information table 31, while the value of a relationship in the response packet is changed in accordance with the relationship between the transmission source of the data and the transmission source of the information request packet.

FIG. 6 is a flowchart explaining an example of a method of reporting quality information. FIG. 6 illustrates an example of a process performed by the communication device 10 between when it receives an information request packet and when it transmits a response packet.

The quality calculation unit 22 calculates the reception quality in the device of the quality calculation unit 22 (step S1). The obtainment unit 21 waits until it receives an information request packet (No in step S2). Receiving an information request packet, the obtainment unit 21 determines whether or not there is a communication device 10 that is connected to the device of itself (Yes in step S2, step S3). When there is a communication device 10 as a child terminal connected to the device of itself, the obtainment unit 21 merges data of the child terminal stored in the connection information table 31 and data of the reception quality in the device of itself calculated by the quality calculation unit 22 (Yes in step S3, step S4). The obtainment unit 21 uses the value in the scope field in the information request packet so as to determine whether or not data of a grandchild terminal is requested (step S5). When data of a grandchild terminal is requested, the obtainment unit 21 determines whether or not there is a grandchild terminal (step S6). In this example, it is assumed that whether or not there is a grandchild terminal has been detected upon the obtainment of the information from the child terminal. When there is a grandchild terminal for the device of itself, the obtainment unit 21 obtains the quality data of the grandchild terminal from the connection information table 31, and merges the data obtained by merging pieces of data of the child terminal and the device of itself with the data of the grandchild terminal (Yes in step S6 and step S7). The obtainment unit 21 adds information such as the header etc. to the generated data so as to generate a response packet and transmits it to the transmission source of the information request packet via the transmitter 12 (step S8).

When it is determined that there are no grandchild terminals for the device of the obtainment unit 21 in S6 as well, it performs the process in step S8 (No in step S6, step S8). Similarly, when it is determined that there are no child terminals for the device of the obtainment unit 21, the obtainment unit 21 performs the process in step S8 (No in step S3, step S8).

(2) Method of Calculating Reception Quality

FIG. 7 illustrates an example of a method of calculating reception quality. By referring to FIG. 7, explanations will be given for an example of a method of calculating reception quality conducted by a device that is in a data distribution system or that is attempting to participate in a data distribution system. In the example illustrated in FIG. 7, a device that distributes distribution data transmits a data packet and a control packet to a device as a distribution destination. Note that examples of devices that distribute distribution data include, in addition to the server 5, a communication device 10 that transmits a packet having distribution data to another communication device 10. In the example of P11 illustrated in FIG. 7, a data packet distributed by the data distribution system includes image data. As depicted as P11, the data packet includes an IP header, an UDP (User Datagram Protocol) header, a sequence number and distribution-target image data. The sequence number represents the order of the image data that is being distributed. Note that the sequence number is included in the packet as information included in the payload.

The control packet is a packet transmitted for reporting the number of the data packets transmitted during a prescribed period of time, and is transmitted for each prescribed period (ΔT). The control packet includes, as depicted as P12, an IP header, a TCP (Transmission Control Protocol) header and a control data. The control data includes the value of the first number of the sequence number included in a data packet that was transmitted after the transmission of the immediately previous control packet, the value of the last number of the sequence number included in the transmitted data packet, and the number of the transmitted packets.

Sequence SEQ1 illustrated in FIG. 7 illustrates an example of a transmission timing for a control packet and a data packet in an exemplary case where data is distributed from the communication device 10B to the communication device 10E. In sequence SEQ1, the transmission of a control packet is represented by a solid arrow, and the transmission of a data packet is represented by a dashed arrow.

It is assumed for example that the relay process unit 27b of the communication device 10B has generated a control packet upon the start of data distribution so as to transmit it to the communication device 10E via the transmitter 12b (arrow A11). Because no data packet had been transmitted before the transmission of the control packet represented by arrow A11, the control packet transmitted from the communication device 10B as represented by arrow A11 includes the following pieces of information.

The first sequence number: 0
The last sequence number: 0
The number of transmitted packets: 0

It is assumed that by a process performed by the relay process unit 27b of the communication device 10B, data packets with the sequence numbers 1 through 100 were thereafter transmitted from the communication device 10B to communication device 10E. The quality calculation unit 22e of the communication device 10E obtains the data packets via the receiver 1e so as to store the sequence numbers included the obtained data packets. In this example, it is assumed that the communication device 10E received the data packets with the sequence number of 1 and with the sequence numbers of 3 through 100. Then, the quality calculation unit 22e stores sequence numbers of 1 and 3 through 100, and the number of the sequence numbers stored in the quality calculation unit 22e is 99.

When transmission period (ΔT) for a control packet has elapsed since the transmission time of the previous control packet, the communication device 10B generates a control packet including the following pieces of information, and transmits the packet to the communication device 10E (arrow A12).

The first sequence number: 1
The last sequence number: 100
The number of transmitted packets: 100

The quality calculation unit 22e in the communication device 10E obtains the control packet via the receiver 11e and obtains the number of the data packets transmitted between the control packet received previously and the control packet transmitted this time and also obtains the sequence numbers. While 100 data packets were transmitted between the control packet received as represented by arrow A11 and the control packet received as represented by arrow A12, the quality calculation unit 22e holds the sequence numbers of only 99 data packets. In response to this situation, the quality calculation unit 22e calculates, as the reception quality, a ratio of the number of the received data packet to the total number of the transmitted data packets. In this example, 99 data packets have been received against the transmission of 100 data packets, and accordingly the quality calculation unit 22e calculates 99% as the reception quality. Finishing the calculation of the reception quality, the quality calculation unit 22e resets the number of the received packets, and continues calculations of reception quality in a similar manner.

It is assumed for example that the communication device 10B transmitted the data packets with the sequence numbers of 101 through 200 toward communication device 10E after the reception of the control packet as represented by arrow A12. It is also assumed that the communication device 10E received the data packets with the sequence numbers of 101 through 180, but did not receive the packets with the sequence numbers of or subsequent to 181. Then, the quality calculation unit 22e stores the fact that the 80 packets with the sequence numbers of 101 through 180 were received after the reception of the control packet as represented by arrow A12.

The communication device 10B generates a control packet including the following pieces of information so as to transmit it to the communication device 10E (arrow A13).

First sequence number: 101
Last sequence number: 200
The number of transmitted packets: 100

While 100 data packets were transmitted between the control packet received as represented by arrow A12 and the control packet received as represented by arrow A13, the quality calculation unit 22e has received only 80 data packets. Then, the quality calculation unit 22e calculates 80% as the reception quality because 80 data packets have been received against the transmission of 100 data packets. Note that transmission interval ΔT for control packets is determined in accordance with the implementation.

(3) Determination of Whether or not to Change Connection Destination

The switching request unit 23 determines when there is a difference in reception quality between a plurality of child terminals, and thereby determines whether or not to change a connection destination of a child terminal that is connected to the device of it.

FIG. 8 illustrates an example of a method for determining whether or not there is a significant difference between levels of reception quality. Cases C11 and C12 illustrated in FIG. 8 show examples of the connections between the communication devices 10A through 10C and the reception quality in each of the communication devices 10A through 10C.

In case C11, the reception quality in the communication device 10A is 100%. While the communication devices 10B and 10C are both child terminals of the communication device 10A, the reception quality in the communication device 10B is 92% and the reception quality in the communication device 10C is 90%. A switching request unit 23a obtains, from the calculation based on for example equation (1), index value (X) for determining whether or not there is a significant difference in reception quality between child terminals.

X=(Rpa−Rc1)/(Rpa−Rc2) (1)

In the above equation, Rpa is a percentage of the reception quality in the parent terminal, Rc1 is a percentage of the reception quality in the child terminal with the highest reception quality, and Rc2 is a percentage of the reception quality in the child terminal with the lowest reception quality. In other words, (Rpa−Rc1) is the minimum value of a difference in reception quality in percentage between the parent terminal and the child terminals, and (Rpa−Rc2) is the maximum value of a difference in reception quality in percentage between the parent terminal and the child terminals. When the index value is smaller than prescribed threshold Th, the switching request unit 23a determines that there is a significant difference in reception quality between child terminals.

It is assumed for example that threshold Th is 0.75. In such a case, index value (X_{C11}) obtained under the circumstance of case C11 is expressed by X_{C11}=(100−92)/(100−90)=8/10=0.8, and the index value is higher than threshold Th in case C11. Accordingly, the switching request unit 23 determines that there are no significant differences in reception quality between communication devices 10B and 10C. When there are no significant differences in reception quality between child terminals and all child terminals have low communication quality as illustrated in case C11, changing of a connection destination for a child terminal is not likely to affect the reception quality in downstream devices because not a particular child terminal is causing the deterioration in the reception quality. Then, the switching request unit 23a determines not to change a connection destination for a child terminal of the device of it, and terminates the process. Note that even when all child terminals connected to a particular communication device 10 have low reception quality, changing of a connection destination on the upstream side of that communication device 10 may improve the reception quality in each communication device 10.

In case C12, the reception quality in the communication device 10A is 100%, the reception quality in the communication device 10B is 96% and the reception quality in the communication device 10C is 90%. In such a case, index value (X_{C12}) obtained under the circumstance as in case C12 is expressed by X_{C12}=(100−96)/(100−90)=4/10=0.4, and in case C12, the index value is lower than threshold Th. Accordingly, the switching request unit 23a determines that there is a significant difference in reception quality between communication devices 10B and 10C. When there is a significant difference in reception quality between child terminals, the switching request unit 23a determines that the communication device 10C having low reception quality may deteriorate reception quality in other communication devices 10, and the switching request unit 23a determines to move the communication device 10C to the downstream side. In other words, the switching request unit 23a has determined that moving of the communication device 10C to the downstream side may prevent a situation in which the communication device 10C deteriorates the reception quality in other communication devices 10. In such a case, processes of searching for a connection destination and of changing a connection destination of a child terminal are performed.

(4) Searching for Connection Destination and Changing of Connection Destination

Hereinafter, processes of searching for a connection destination and of changing a connection destination will be explained by referring to several patterns for them.

(4.1) Pattern 1

By referring to FIG. 9 through FIG. 11, a specific example of processes performed when a parent terminal moves its child terminal to the downstream side of a grandchild terminal. Note that in FIG. 9 through FIG. 11, which show an example of a communication process in network N1 (FIG. 5), some of the communication devices 10 are omitted in some cases for the sake of better understanding.

Case C21 illustrated in FIG. 9 illustrates a case where the switching request unit 23a of communication device 10A determines that there is a significant difference in reception quality between the communication devices 10B and 10C. In the example of case C21, the reception quality in the communication devices 10A and 10B are 100%, and the reception quality in the communication devices 10C and 10D are 90%. Meanwhile, the reception quality of the communication device 10E is 99% and the reception quality of the communication device 10F is 89%.

The 31a-1 illustrated in FIG. 9 is an example of the connection information table 31 for a case when the communication device 10A holds information of terminals up to a grandchild terminal of the communication device 10A in case C21. Because there is a significant difference in reception quality between child terminals, the switching request unit 23a determines whether or not there is a grandchild terminal having reception quality higher than that of a child terminal. In the example of the connection information table 31a-1, the reception quality of the communication device 10E, which is a grandchild terminal of the communication device 10A, is higher than the reception quality of the communication device 10C, which is a child terminal of the communication device 10A. Accordingly, when the communication device 100E may establish a new connection, the switching request unit 23a determines that a connection destination of the communication device 10C may be changed to the communication device 10E. However, in the example of connection information table 31a-1, the communication device 10E does not establish a new connection to other devices. Then, the switching request unit 23a requests that the obtainment unit 21a obtain connection information from the communication device 10E in order to determine whether or not the communication device 10C may be connected to a device with reception quality higher than that of the communication device 10C from among devices connected to the communication device 10E. In response to a request from the switching request unit 23a, the obtainment device 21a transmits an information request packet toward the communication device 10E through a process similar to that explained with reference to FIG. 5 or other figures. It is assumed that the obtainment unit 21a requested from the communication device 10E information of terminals up to a grandchild terminal of the communication device 10E.

Receiving the information request packet via the receiver 11e, the obtainment unit 21e of the communication device 10E generates a response packet including information of terminals up to a grandchild of the communication device 10E, and transmits it to the communication device 10A via the transmitter 12e. The obtainment unit 21a processes data in the response packet received from the communication device 10E, and thereby updates the connection information table 31.

The connection information table 31a-2 illustrated in FIG. 10 is an example of the connection information table 31 that has been updated through the process by the obtainment unit 21a. Case C22 illustrated in FIG. 10 illustrates a result of illustrating a network using the information obtained from the communication device 10E. The reception quality in the communication devices 10G and 10I is 99%, and the reception quality in the communication devices 10H and 10J is 90%. Meanwhile, the reception quality in the communication devices 10A through 10F do not vary between cases C22 and C21 (FIG. 9).

When the connection information table 31 is updated, the switching request unit 23a determines whether or not there is a communication device 10 with reception quality higher than that of its child terminal among the communication devices 10 that are receiving data via their grandchild terminals. In the example illustrated in the connection information table 31a-2, the reception quality in the communication device 10G, which is a child terminal of the communication device 10E, and the reception quality in the communication device 10I, which is a grandchild terminal of the communication device 10E, are higher than that of the communication device 10C, which is a child terminal of the communication device 10A. Accordingly, when the communication device 10G may establish a new connection, the switching request unit 23a determines that a connection destination of the communication device 10C may be changed to the communication device 10G. The connection information table 31a-2 records information indicating that the communication device 10G may establish a new connection.

FIG. 11 illustrates an example of a process of changing a connection destination. Case C23 illustrates an example of a process performed when it is determined that a connection destination of the communication device 10C is to be changed to the communication device 10G. The switching request unit 23a generates a switching request packet, addressed to the communication device 10C, requesting that the IP address of a new connection destination be set to 10.0.0.7 (communication device 10G). The switching request packet is transmitted from the transmitter 12a to the communication device 10C (arrow A21). Receiving the switching request packet, the receiver 11c of the communication device 10C outputs it to the connection process unit 25c. The connection process unit 25c uses data in the switching request packet so as to disconnect the communication between the communication devices 10A and 10C, and establishes a connection between the communication devices 10C and 10G (arrows A22 and A23).

A connection destination of the communication device 10C is changed to the communication device 10G as described above, making it possible to avoid a situation where a communication device 10 with low reception quality remains on the upstream side of a distribution system and deteriorates the efficiency of communications in the distribution system.

Next, by referring to cases C24 and C25 illustrated in FIG. 11, explanations will be given for an example of a process performed in a case where a connection destination of a child terminal is changed and thereafter a new connection destination of that former child terminal is connected to the parent terminal. The switching request unit 23c of the communication device 10C transmits to the communication device 10G a report packet reporting that the communication device 10C was connected to the communication device 10A (10.0.0.1) before the connection to the communication device 10G (arrow A24).

The connection process unit 25g in the communication device 10G obtains a packet from the communication device 10C via the receiver 11g. The connection process unit 25g recognizes, by using a report packet, that a connection destination of the communication device 10C has been changed to the communication device 10G from the communication device 10A. Then, the connection process unit 25c determines that a connection to the communication device 10A may be established because the connection between the communication devices 10C and 10A was abandoned. Then, the connection process unit 25g disconnects the communication between the communication devices 10G and 10E (A25). Thereafter, the connection process unit 25g transmits a connection request packet to the communication device 10A so as to request the establishment of a connection (arrow A26).

The connection process unit 25a of the communication device 10A obtains the connection request packet from the communication device 10G via the receiver 11a. The connection process unit 25a establishes the connection between the communication devices 10A and the communication device 10G by using information in the connection request packet. Case C25 illustrates the connection between the communication devices 10A and 10G.

As illustrated in case C25, in response to the establishment of the connection between the communication devices 10A and 10G, the relay process unit 27a in the communication device 10A relays data obtained in the communication device 10A to the communication device 10G. In this situation, the communication devices 10B and 10G are child terminals of the communication device 10A, and the reception quality of both is good. Accordingly, the process explained as pattern 1 may prevent a situation where a communication device 10 with low reception quality in the upstream side in a distribution system deteriorates the communication efficiency in the entire distribution system.

While an example has been used by referring to case C24 in which the communication device 10C having moved to the downstream side reports a new connection destination to the communication device 10G, information of a connection destination of a new child terminal may be reported from the parent terminal to a communication device 10 that becomes a new child terminal. Also, the communication device 10A (parent terminal) may include information of a changing destination of a connection of the communication device 10G, which becomes a new connection destination of the communication device 10C, in a switching request packet transmitted to the communication device 10C (child terminal) that is to be moved. In such a case, communication device 10C reports, to the communication device 10G, information of a connection destination for the communication device 10G included in the switching request packet. Then, the communication device 10G may change a connection destination on the basis of a report from the communication device 10C.

(4. 2) Pattern 2

In pattern 1, the communication device 10A determines to make the communication device 10C be connected to a terminal device that is connected to the communication device 10E, which is a grandchild terminal, however, a new connection might not be formed in a connection destination of a grandchild terminal in some networks. Processes performed in such a case will be explained as pattern 2 by referring to FIG. 12.

Case C31 illustrated in FIG. 12 illustrates connections between communication devices 10 and the reception quality obtained in each of the communication devices 10. In case C31, the reception quality is 100% in the communication devices 10A and 10B, the reception quality is 90% in the communication device 10C, and the reception quality is 98% in the communication device 10D. The reception quality is 99% in the communication devices 10E, 10G and 10I. Further, the reception quality is 90% in the communication devices 10H and 10J, and the reception quality is 89% in the communication device 10F.

In a network as illustrated in case C31, the communication device 10A holds the connection information table 31a-3. As illustrated in the connection information table 31a-3, the communication devices 10D, 10E, 10G and 10I are communicating with reception quality higher than that of the communication device 10C, which is a child terminal of the communication device 10A. However, the pieces of the connection possible/impossible information of both of the communication device 10D and the communication device 10E, which are grandchild terminals of the communication device 10A are NG, and thus neither of the communication devices 10D and 10E will become a connection destination of the communication device 10C.

Next, the switching request unit 23a determines whether or not the communication device 10C may be connected to the communication device 10G, which is a child terminal of the communication device 10E. In the connection information table 31a-3, the connection possible/impossible information of the communication device 10G is NG, and thus, the switching request unit 23a determines not to connect the communication device 10C to the communication device 10G.

Because the reception quality in the communication device 10I as a child terminal of the communication device 10G is 99%, which is higher than that of the communication device 10C, the switching request unit 23a determines that the communication device 10C may be connected to the communication device 10I. In the connection information table 31a-3, the connection possible/impossible information of the communication device 10I is also NG, and thus the switching request unit 23a determines not to connect the communication device 10C to the communication device 10I.

Next, because the reception quality of the communication device 10D, which is a grandchild terminal different from the communication device 10E, is also higher than that of the communication device 10C, the switching request unit 23a determines to transmit an information request packet to the communication device 10D. The information request packet is transmitted, and information of a child terminal of the communication device 10D etc. is reported to the communication device 10A from the obtainment unit 21d in the communication device 10D. It is now assumed that a child terminal of the communication device 10D (communication device 10K, not shown) has reception quality higher than that of the communication device 10C and that a new connection may be formed. In such a case, the switching request unit 23a determines the communication device 10K to be a connection destination of the communication device 10C.

Processes performed after the determination of a connection destination by the switching request unit 23a are similar to those explained by referring to FIG. 11. Accordingly, in the case of pattern 2, the communication device 10C ceases to be a child terminal of the communication device 10A by being connected to the communication device 10K. Also, the processes explained with reference to cases C24 and C25 are performed on an as-needed basis, the communication device 10K may become a new child terminal of the communication device 10A.

Note that when the switching request unit 23a determines not to connect the communication device 10C to the communication device 10I, the switching request unit 23a may request information of a child terminal of the communication device 10I etc. from the communication device 10I. Thereafter, the switching request unit 23a performs processes similar to those explained with reference to FIG. 12, and thereby may search for a connection destination of the communication device 10C.

(4. 3) Pattern 3

By referring to FIG. 13, explanations will be given for a specific example of a case where a child terminal may change a connection destination to a grandchild terminal that is connected to a different child terminal. It is assumed for example that the communication devices 10 are connected as illustrated in case C41. It is assumed that the reception quality in the communication devices 10A and communication device 10B is 100%. The reception quality in the communication device 10D is 98% and the reception quality in the communication device 10E is 99%. In this example, the communication devices 10D and 10E are grandchild terminals of the communication device 10A. Also, the reception quality of the communication device 10C, which is a child terminal of the communication device 10A, is 90%, and the reception quality in the communication device 10D, which is connected to the communication device 10C, is 89%.

The connection information table 31a-4 illustrated in FIG. 13 illustrates an example of the connection information table 31 used in a case when the communication device 10A holds information of terminals up to grandchild terminal in case C41. The switching request unit 23a determines whether or not there is a grandchild terminal with reception quality higher than that of a child terminal. In the example of the connection information table 31a-4, the reception quality of the communication devices 10D and 10E is higher than that of the communication device 10C, which is a child terminal of the communication device 10A. In response to this, when the communication device 10E may establish a new connection, the switching request unit 23a determines that a connection destination of the communication device 10C may be changed to the communication device 10E. However, as illustrated in the connection information table 31a-4, the communication device 10E does not establish a new connection to a different device in the example illustrated in FIG. 13. Next, the switching request unit 23a determines whether or not the communication device 10C may be connected to the communication device 10D. As illustrated in the connection information table 31a-4, the connection possible/impossible information of the communication device 10D is set to be OK, and thus the communication device 10D may newly establish a connection to a different communication device 10. Then, the switching request unit 23a determines the communication device 10D to be a connection destination of the communication device 10C.

Processes performed after the determination of a connection destination by the switching request unit 23a are similar to that explained by referring to FIG. 11. Accordingly, in the case of pattern 3, the communication device 10C is connected to the communication device 10D, and thereby ceases to be a child terminal of the communication device 10A. This prevents a situation where a connection of a communication device 10 with low reception quality remains on the upstream side in a distribution system and causes deterioration in the communication efficiency.

(4. 3) Pattern 4

By referring to FIG. 14, explanations will be given for a case where there is no communication device 10 that is receiving data via a child terminal and that is with reception quality higher than that of a child terminal. It is assumed for example that the communication devices 10 are connected as illustrated in case C51. The reception quality is assumed to be 100% in the communication devices 10A and 10B. The reception quality is 99% in the communication device 10C, which is a child terminal of the communication device 10A. Meanwhile, the reception quality is 99% in the communication devices 10D and 10E, which are grandchild terminals of the communication device 10A, and the reception quality is 98% in the communication device 10F.

The connection information table 31a-5 illustrated in FIG. 14 illustrates an example of the connection information table 31 used in a case when the communication device 10A holds information of terminals up to a grandchild terminal in case C51. The switching request unit 23a determines whether or not there is a grandchild terminal with reception quality higher than that of a child terminal. In the example of the connection information table 31a-5, the reception quality of the communication devices 10D and 10E is equal to or lower than that of the communication device 10C, which is a child terminal of the communication device 10A. In such a case, the switching request unit 23a determines not to change a connection destination of the communication device 10C, and terminates the process.

FIG. 15A and FIG. 15B are flowcharts explaining an example of a method of searching for a connection destination. In FIG. 15A and FIG. 15B, time-sequential explanations will be given for the flow of the entire process from the obtainment of information used for changing a connection destination to changing of the connection destination.

The obtainment unit 21 waits until a timing of a periodic process for obtaining information related to a connection in a child terminal (No in step S11). When a timing of a periodic process for obtaining information related to a connection in a child terminal arrives, the obtainment unit 21 determines whether or not there is a child terminal that is connected to the device of it (step S12). When there is no child terminal connected the device of it, the process returns to step S11 (No in step S12). When there is a child terminal connected the device of it, the obtainment unit 21 transmits an information request packet to each of the child terminals (Yes in step S12, step S13). The obtainment unit 21 waits until response packets are received from all the child terminals to which the information request packets were transmitted (No in step S14). Receiving response packets from all the child terminals to which the information request packets were transmitted, the obtainment unit 21 records in the connection information table 31 information included in received packets (Yes in step S14, step S15).

The switching request unit 23 determines whether or not there is a significant difference in reception quality between child terminals (step S16). When there is no significant difference in reception quality between child terminals, the process returns to step S11 (No in step S16). When there is a significant difference in reception quality between child terminals, the switching request unit 23 determines whether or not there is a grandchild terminal of the device of it (Yes in step S16, step S17). When the device of it has no grandchild terminals, the process returns to step S11 (No in step S17).

When the device of the switching request unit 23 has a grandchild terminal, the switching request unit 23 determines whether or not there is a grandchild terminal with reception quality higher than the lowest quality of a child terminal (Yes in step S17, step S18). When there is no grandchild terminal with reception quality higher than the lowest quality of a child terminal, the process returns to step S11 (No in step S18). When there is a grandchild terminal with reception quality higher than the lowest quality of a child terminal, the switching request unit 23 determines whether or not there is a communication device 10 that may establish a new connection from among grandchild terminals with reception quality higher than that of a child terminal (Yes in step S18, step S19). When there is a grandchild terminal that is with reception quality higher than that of a child terminal and that may establish a new connection, the switching request unit 23 selects, as a new connection destination, device that is with high reception quality and that is connected on the downstream side from among such communication devices 10 (Yes in step S19, step S20). The switching request unit 23 requests that a child terminal with low reception quality switch its connection to the communication device 10 selected as a new connection destination (step S21).

When there is no grandchild terminal that is with reception quality higher than that of a child terminal and that may establish a new connection, the obtainment unit 21 selects the communication device 10 with the highest reception quality from among grandchild terminals with reception quality higher than that of a child terminal (No in step S19, step S22). The obtainment unit 21 transmits to the selected communication device 10 an information request packet for requesting quality information of the child terminal and the grandchild terminal of that communication device 10 (step S23). The obtainment unit 21 waits until a response packet is received from the selected communication device 10 (No in step S24).

Receiving a response packet from the selected communication device 10, the obtainment unit 21 determines whether or not the obtained information includes information of the communication device 10 with reception quality higher than that of the lowest quality of a child terminal (Yes in step S24, step S25). When the information in the response packet does not include the information of the communication device 10 with reception quality higher than that of the lowest quality of a child terminal, the process returns to step S11 (No in step S25).

When there is a communication device 10 with reception quality higher than the lowest quality of a child terminal, the switching request unit 23 determines that there is a connectable device among the communication devices 10 with reception quality higher than the lowest quality of a child terminal (Yes in step S25, step S26). When there is a connectable device among the communication devices 10 with reception quality higher than the lowest quality of a child terminal, the switching request unit 23 performs the processes in and subsequent to step S20 (Yes in step S26).

When a connection destination with reception quality higher than that of the lowest quality of a child terminal is not found, the obtainment unit 21 determines whether or not there is a communication device 10 that has not transmitted an information request packet among the communication devices 10 with reception quality higher than the lowest quality of a child terminal (No in step S26, step S27). When there is a communication device 10 that has not transmitted an information request packet among the communication devices 10 with reception quality higher than the lowest quality of a child terminal, the obtainment unit 21 determines to transmit an information request packet (Yes in step S27). The obtainment unit 21 selects, as a transmission destination of the information request packet, the communication device 10 with relatively high quality from among the devices that have not transmitted an information request packet (step S28). After the process in step S28, the processes in and subsequent to step S23 are performed. When there is no communication device 10 that has not transmitted information request packet among the communication devices 10 with reception quality higher than the lowest quality of a child terminal, the process returns to step S11 (No in step S27).

Note that FIG. 15A and FIG. 15B show an example of processes. For example, the processes in steps S14 and S15 may be performed in parallel. In such a case, the obtainment unit 21 sequentially writes data extracted from a received response packet to the connection information table 31. Also, step S20 is an example of a method of selecting the communication device 10 as a connection destination, and may be changed in accordance with the implementation.

FIG. 16 is a flowchart explaining an example of a method of comparing levels of reception quality. The flowchart illustrated in FIG. 16 explains in detail the process performed in step S16 illustrated in FIG. 15A. The equation used for the determination process in step S42 in FIG. 16 may be changed in accordance with the implementation. For example, the equation used in step S42 is for obtaining the inverse number of equation (1) used for explaining FIG. 8.

The switching request unit 23 calculates, for each child terminal, a difference in reception quality between that child terminal and the device of the switching request unit 23 (step S41). The switching request unit 23 determines whether or not the ratio of the maximum value as the difference in reception quality from the child terminal is equal to or higher than a threshold with respect to the minimum value as the difference in reception quality from the child terminal (step S42). When the ratio of the maximum value as the difference in reception quality from the child terminal is equal to or higher than the threshold with respect to the minimum value as the difference in reception quality from the child terminal, the switching request unit 23 determines that there is a significant difference in reception quality between child terminals (Yes in step S42, step S43). When the ratio of the maximum value as the difference in quality from the child terminal is lower than the threshold with respect to the minimum value as the difference in reception quality from the child terminal, the switching request unit 23 determines that there is no significant difference in reception quality between child terminals (No in step S42, step S44).

FIG. 17 illustrates a flowchart for explaining an example of a method of changing a connection destination. FIG. 17 explains a process performed by the connection process unit 25 after the process in step S21 illustrated in FIG. 15B. The receiver 11 waits until a switching request packet is received (No in step S51). Obtaining a switching request packet, the connection process unit 25 identifies a new connection destination so as to perform a process of switching a connection destination (step S52). The switching request unit 23 waits until the switching request process is terminated (No in step S53).

The switching request unit 23 determines whether or not the switching request packet includes a reporting IP address to be reported to a connection destination device (Yes in step S53, step S54). When a reporting IP address to be reported to a connection destination device is not included, the process returns to step S51 (No in step S54). When a reporting IP address to be reported to a connection destination device is included, the switching request unit 23 requests that a communication device 10 as a new connection destination switch to the device to which the report IP address has been assigned (step S55).

As described above, the method according to an embodiment moves a communication device 10 with low reception quality to the data distribution system from the upstream side, preventing a situation where a communication device 10 with low reception quality on the upstream deteriorates the reception quality of other communication devices 10. Also, in a system to which the method of an embodiment is applied, reception quality deterioration and retransmissions, a communication disconnection, etc. due to reception quality deterioration become less likely to occur, leading to higher communication efficiency.

Also, according to the method of an embodiment, it is also easy to prevent a situation where an increase in the number of layers on a route including some of devices in a tree distribution system deteriorates the reception quality. In a case when for example one of the child terminals of a device has low reception quality while the other has high reception quality, a communication device 10 that participates in the distribution system is often connected to the child terminal having high reception quality or to a device that receives data via the device with high reception quality in order to achieve high reception quality. In such a case, because many communication devices 10 receive data via only some of the child terminals in a data distribution system, the number of the layers increases in a route used by child terminals with high reception quality. By contrast, the method according to an embodiment moves a terminal device with low reception quality from among child terminals to the downstream side, making the above imbalance in the numbers of layers less likely to occur. Further, as explained by referring to FIG. 11, the method of an embodiment may move a terminal device with high reception quality to the upstream side after moving a terminal device with low reception quality to the downstream side. This also prevents a situation where an increased number of layers in a data distribution system increases the number of times of transfer and makes reception quality deterioration more likely to occur.

In a system according to an embodiment, it is possible to prevent deterioration in reception quality in a data distribution system.

### Variation Example

Note that the scope of the embodiments is not limited to the above descriptions, and various modifications are possible. Examples thereof will be described below.

When a communication device 10 on the downstream side of a child terminal is treated as a new child terminal in response to moving of a child terminal to the downstream side, the parent terminal may treat, as a new child terminal, a device that is not a connection destination of the child terminal moved to the downstream side. It is assumed for example as illustrated in case C24 in FIG. 11 that the communication device 10C, which was a child terminal of the communication device 10A, has changed its connection destination from the communication device 10A to the communication device 10G on the downstream side. In this process, the switching request unit 23a of the communication device 10A may select a communication device 10 as a new child terminal from among grandchild terminals, with reception quality higher than that of the communication device 10C, of the communication device 10A or from among the communication devices 10 that are with reception quality higher than that of the communication device 10C and that are connected to a portion on the downstream side of grandchild terminals of the communication device 10A. In the example of case C24 for example, the switching request unit 23a may determine to treat as a new child terminal one of the communication devices 10E, 10G and 10I. In such a case, the switching request unit 23a transmits, to the communication device 10 that is to be treated as a new child terminal, a switching request packet for requesting a connection to the communication device 10A. In the communication device 10 having received the switching request packet, the connection process unit 25 performs a process for establishing a connection to the communication device 10A. Upon the connection of the new child terminal to the communication device 10A, the relay process unit 27a performs a data relay process also on the new child terminal.

Different methods, depending upon the implementation, may be employed for calculating an index value used for determining whether or not there is a significant difference in reception quality between child terminals. For example, whether or not there is a significant difference in reception quality between child terminals may be determined by a difference between levels of reception quality in a child terminal. Note that a value set as a threshold may also be changed in accordance with the calculation methods of an index value.

The information elements in the packet formats and the tables explained above are exemplary, and may be changed in accordance with the implementations.

In the example of FIG. 8, a case with two child terminals has been explained as an example of determining whether or not there is a difference in reception quality between child terminals, whereas the number of child terminals may be changed arbitrarily in accordance with the implementations.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A communication system comprising:
a first communication device that receives distribution of data;
a plurality of transfer destination devices to which the first communication device transfers the data; and
a plurality of communication devices that receive the data via any of the plurality of transfer destination devices, wherein
the first communication device requests that a second communication device included among the plurality of transfer destination devices receive the data from a third communication device included among the plurality of communication devices when reception quality of the data in the third communication device is higher than reception quality of the data in the second communication device,
the second communication device receives a request from the first communication device, and
the second communication device changes a connection destination from the first communication device to the third communication device.

2. The communication system according to claim 1, wherein
the first communication device
selects a target device from among devices that are receiving the data with reception quality higher than that of the second communication device among the plurality of communication devices,
requests that the target device change a transfer source of the data to the first communication device, and
transfers the data to the target device when the target device is connected to the first communication device.

3. The communication system according to claim 1, wherein
the second communication device reports to the third communication device a fact that a connection destination of the second communication device before being connected to the third communication device is the first communication device,
the third communication device is connected to the first communication device, and
the first communication device transfers the data to the third communication device after establishment of a connection to the third communication device.

4. The communication system according to claim 1, wherein
the first communication device
obtains, for each of the plurality of communication devices, information representing whether or not the communication device is a device that is able to distribute the data to a different communication device in addition to a device to which the communication device is transferring the data, and
selects, as the third communication device, a device that is with reception quality of the data higher than that of the second communication device and that is able to distribute the data to the different communication device, from among the plurality of communication devices.

5. The communication system according to claim 1, wherein
the first communication device
changes a transfer source of the data of the second communication device to the third communication device when an index value is equal to or greater than a threshold, the index value being calculated in such a manner that the greater a difference in reception quality of the data between the plurality of transfer destination devices is, the greater the index value is, and
does not change a transfer source of the data of the second communication device when the index value is smaller than the threshold.

6. A communication method for a distribution system in which data transmitted from a distribution source is distributed, comprising:
receiving, by a first communication device, the data,
transferring, by the first communication device,
the data to a plurality of transfer destination devices including a second communication device,
requesting, by the first communication device, when detecting a third communication device with reception quality higher than that of the second communication device from among a plurality of communication devices receiving the data via any of the plurality of transfer destination devices, that the second communication device receive the data from the third communication device, and wherein
the second communication device receives a request from the first communication device and changes a connection destination from the first communication device to the third communication device.

7. The communication method according to claim 6, wherein
the first communication device
selects a target device from among devices that are receiving the data with reception quality higher than that of the second communication device among the plurality of communication devices,
requests that the target device change a transfer source of the data to the first communication device, and
transfers the data to the target device when the target device is connected to the first communication device.

8. The communication method according to claim 6, wherein
the first communication device
obtains, for each of the plurality of communication devices, information representing whether or not the communication device is a device that is able to distribute the data to a different communication device in addition to a device to which the communication device is transferring the data, and
selects, as the third communication device, a device that is with reception quality of the data higher than that of the second communication device and that is able to distribute the data to the different communication device, from among the plurality of communication devices.

9. The communication method according to claim 6, wherein
the first communication device
changes a transfer source of the data of the second communication device to the third communication device when an index value is equal to or greater than a threshold, the index value being calculated in such a manner that the greater a difference in reception quality of the data between the plurality of transfer destination devices is, the greater the index value is, and
does not change a transfer source of the data of the second communication device when the index value is smaller than the threshold.

10. A communication device in a distribution system in which data transmitted from a distribution source is distributed, the communication device comprising:
a receiver that receives the data;
a transmitter that transfers the data to a plurality of transfer destination devices including a first communication device; and
a processor that requests, when detecting a second communication device with reception quality higher than that of the first communication device from among a plurality of communication devices receiving the data via any of the plurality of transfer destination devices, that the first communication device receive the data from the second communication device.

11. The communication device according to claim 10, wherein
the processor
selects a target device from among devices that are receiving the data with reception quality higher than that of the first communication device among the plurality of communication devices, and
generates a control packet that reports to the target device a fact that transfer of the data is possible, and
the transmitter transmits the control packet to the target device, and also transfers, when a connection to the target device is established, the data to the target device.

12. The communication device according to claim 10, wherein
the processor
obtains, for each of the plurality of communication devices, information representing whether or not the communication device is a device that is able to distribute the data to a different communication device in addition to a device to which the communication device is transferring the data, and
selects, as the second communication device, a device that is with reception quality of the data higher than that of the first communication device and that is able to distribute the data to the different communication device, from among the plurality of communication devices.

13. The communication device according to claim 10, wherein
the processor
changes a transfer source of the data of the first communication device to the second communication device when an index value is equal to or greater than a threshold, the index value being calculated in such a manner that the greater a difference in reception quality of the data between the plurality of transfer destination devices is, the greater the index value is, and
does not change a transfer source of the data of the first communication device when the index value is smaller than the threshold.

14. A non-transitory computer-readable recording medium having stored therein a program for causing a first communication device, included in a distribution system in which data transmitted from a distribution source is distributed, to execute a process comprising:
receiving the data;
transferring the data to a plurality of transfer destination devices including a second communication device; and
requesting, when detecting a third communication device with reception quality higher than that of the second communication device from among a plurality of communication devices receiving the data via any of the plurality of transfer destination devices, that the second communication device receive the data from the third communication device.

15. The recording medium according to claim 14, wherein
the program causes the first communication device to execute a program comprising:
selecting a target device from among devices that are receiving the data with reception quality higher than that of the second communication device among the plurality of communication devices,
generating a control packet that reports to the target device a fact that transfer of the data is possible,
transmitting the control packet to the target device, and
transferring the data to the target device when a connection to the target device is established.
